(19) United States
(12) Patent Application Publication
(10) Pub. No.: US 2026/0084395 A1
(43) Pub. Date: Mar. 26, 2026

(54) A DEVICE FOR LONGITUDINAL PROCESSING OF A CORRUGATED BOARD WEB

(71) Applicant: Fosber S.p.A., Pescaglia (IT)

(72) Inventor: Mauro ADAMI, Viareggio (IT)

(73) Assignee: Fosber S.p.A., Pescaglia, LU (IT)

(21) Appl. No.: 18/714,202

(22) PCT Filed: Nov. 28, 2022
(86) PCT No.: PCT/EP2022/083526

§ 371 Date: May 29, 2024

(30) Foreign Application Priority Data
Dec. 1, 2021 (IT) 102021000030422

(51) Int. Cl. B31F 1/10

(52) U.S. Cl. CPC B31F 1/10

(57) ABSTRACT

The device includes a feed path of the corrugated board web. A first series of rotary tools is provided on a first side of the feed path of the corrugated board web, each supported by a respective slide slidably engaged with a first adjustment guide and adjustable along the first adjustment guide. The first adjustment guide extends in a direction transverse to the feed direction of the corrugated board along the feed path. A first manipulator adapted to position the slides of the first series of rotary tools along the first adjustment guide is slidably engaged with the first adjustment guide and is movable therealong.

### DESCRIPTION

### Technical Field

The present invention relates to the field of corrugated board production. More specifically, the present invention relates to improvements to devices for the longitudinal processing of corrugated board webs, in particular scoring devices, for longitudinally processing continuous corrugated board webs.

### Background Art

To produce boxes and other articles in corrugated board, plants are used which bond together webs of smooth paper and corrugated paper, to form a corrugated board web comprising at least one sheet of corrugated paper and one sheet of smooth paper, or more frequently at least two outer smooth paper sheets (so-called liners), between which a sheet of corrugated paper is arranged and glued. The continuous corrugated board web is divided into individual strips, each of which is then cut transversely into individual sheets. Each strip is also scored to form longitudinal fold lines. Longitudinal cutting and longitudinal scoring of the strips are performed in one or more scoring and cutting units. Scoring and cutting are performed by rotary tools rotating around rotation axes.

Examples of scoring and cutting units are disclosed in U.S. Pat. Nos. 8,342,068; 6,165,117; and 6,092,452; US20190270214; US2013260975; EP3556523; EP0894583; EP0354515; EP0085387.

The longitudinal strips, into which the corrugated board web is divided, have variable widths depending on the final dimensions of the corrugated board sheets to be produced for a given production order. Orders are often very small, i.e. made up of a limited number of sheets. When changing the order, it is necessary to position the (scoring or cutting) rotary tools quickly and precisely. To this end, various configurations of positioning members have been studied for translating the rotary tools in a transverse direction, i.e. orthogonally to the feed direction of the corrugated board web along the feed path.

EP1179415 discloses, for example, a system for positioning rotary disc tools. The system comprises a plurality of tool-holder slides, each provided with a respective rotary tool and a nut screw. The nut screw may be selectively constrained and released with respect to the tool-holder slide. The nut screws mesh with a common threaded rod. The positioning of the individual slides, and therefore of the rotary tools, takes place by selectively binding the nut screws to the slides to be translated and positioned in a transverse direction with respect to the feed direction of the web material to be cut, and by rotating the threaded bar. This positioning mechanism is relatively complex and slow in operation.

Therefore, in the field of machines and plants for the production of corrugated board there is a need to implement a cutting or scoring device, or a cutting and scoring device, which comprises a system that overcomes in whole or in part the drawbacks of prior art systems. In particular, there is a need to implement a simple, efficient, reliable and fast positioning system.

### Summary

According to an aspect, a device for the longitudinal processing of a corrugated board web is disclosed, comprising a feed path of the corrugated board web. A first series of rotary tools is placed on a first side of the feed path of the corrugated board web. Each rotary tool of the first series of rotary tools is supported on a respective slide slidably engaged with a first adjustment guide and adjustable along the first adjustment guide. The first adjustment guide extends in a direction transverse to the direction of feed of the corrugated board along the feed path and parallel to the lying plane of the corrugated board web advancing along such feed path. Preferably, the direction of the adjustment guide is orthogonal to the feed direction of the corrugated board web and therefore to the feed path.

The device further comprises a first manipulator adapted to position the slides of the first series of rotary tools along the first adjustment guide. The first manipulator is slidably engaged with the first adjustment guide and is movable therealong.

In essence, therefore, the manipulator and the slides that carry the rotating tools are sliding along a common guide. This substantially simplifies the structure of the device.

In the simplest embodiment, the device comprises a single manipulator which positions all the tools. Preferably, for example in order to obtain a more rapid positioning of the tools and therefore to simplify and accelerate the changeover from one processing order to another, it is advantageous to provide, on the same side of the feed path of the corrugated board web, a first manipulator and a second manipulator. The first manipulator is used to position the rotary tools of a first series of rotary tools and the second manipulator is used to position the rotary tools of a second series of rotary tools. The two series of rotary tools may comprise the same number of rotary tools, or a different number of rotary tools.

Depending on the type of rotary tools, a similar third manipulator and possibly a similar fourth manipulator may be provided on the second side of the path to position a third series of tools and possibly a fourth series of rotary tools. Also included in the possible configurations disclosed herein is a configuration with a single manipulator on a first side of the feed path, to position a first series of rotary tools, and a further manipulator on a second side of the feed path to position the rotary tools of a further series of rotary tools.

The indication “on a first side” and “on a second side” of the feed path is intended to identify a position in front of a first face and a second face of the corrugated board web that advances along the feed path. Typically, the corrugated board feed path is an approximately horizontal path and therefore by “on the first side of the feed path” and “on the second side of the feed path, respectively, it is meant “above” and “below” the feed path, respectively, or vice versa.

Horizontal indicates a direction orthogonal to the direction of the force of gravity.

Each manipulator may advantageously comprise respective engaging members adapted to temporarily constrain each slide of the respective series of rotary tools.

For example, the engaging members may comprise at least one engaging element adapted to engage at least one slide of at least one rotary tool of the respective series of rotary tools with the respective manipulator.

In other embodiments, the engaging members comprise a plurality of engaging elements, each adapted to engage a respective slide of one of the rotary tools of the respective series of rotary tools. Each of said engaging elements is advantageously activatable and deactivatable independently of the other engaging elements, so as to be able to selectively constrain and release each rotary tool of the respective series of rotary tools from the respective manipulator. This allows the possibility to perform very fast positioning cycles.

To make the system more compact and positioning faster, in embodiments it is possible to provide that one or more of the manipulators supports a respective rotary tool. In this way, the positioning cycle is shorter, as will become apparent from the detailed description of exemplary embodiments of the positioning cycle of the rotary tools.

According to another aspect, a device for longitudinal processing of a corrugated board web is described herein, comprising:
a feed path of the corrugated board web;
on a first side of the feed path of the corrugated board web, a first series of rotary tools; wherein each rotary tool of the first series of rotary tools is supported on a respective slide, slidably engaged with a first adjustment guide and adjustable along said first adjustment guide; wherein the first adjustment guide extends in a direction transverse to the direction of feed of the corrugated board along the feed path;
a first manipulator adapted to position the slides of the first series of rotary tools along the first adjustment guide, moving along an adjustment guide which may coincide with that on which the slides move, or may be parallel to the latter;
respective engaging members supported on the first manipulator and adapted to temporarily constrain each slide to transfer it in the correct position; and
at least one of said rotary tools supported on the first manipulator.

With this configuration, the number of tools that must be engaged by the manipulator, translated into position and released is reduced. In practice, the manipulator itself constitutes the adjustment slide of one of the rotary tools.

In more advanced embodiments, one or preferably two manipulators may be provided on one or on each side of the corrugated board path (i.e. above and below it), as described in detail below with reference to embodiments illustrated in the accompanying drawings.

According to a further aspect, a device for longitudinal processing of a corrugated board web is described, comprising:
a feed path of the corrugated board web;
on at least a first side of the feed path of the corrugated board web, a first series of rotary tools; wherein each rotary tool of the first series of rotary tools is supported on a respective slide, slidably engaged with a first adjustment guide and adjustable along said first adjustment guide; wherein the first adjustment guide extends in a direction transverse to the direction of feed of the corrugated board along the feed path;
a first manipulator adapted to position the slides of the first series of rotary tools along the first adjustment guide, moving along an adjustment guide which may coincide with that on which the slides move, or may be parallel to the latter;
on the first manipulator, engaging members adapted to temporarily constrain each slide of the first series of rotary tools; wherein the first engaging members comprise a plurality of first engaging elements, each adapted to engage a respective slide of one of the rotary tools of the first series of rotary tools; and wherein each of said first engaging elements is activatable and deactivatable independently from the other first engaging elements.

In this way, the tool positioning cycle becomes particularly fast, as will be apparent from the following description referring to the accompanying drawings. In fact, single slides of several rotary tools may be simultaneously engaged and translated by the manipulator, which then, by individually deactivating the single engaging elements, releases each slide in a different position. The movements of the manipulator are minimized and optimized.

While a configuration is described below in which the manipulator and the slides slide on the same adjustment guide, some of the above advantages are obtained even if the manipulator on one end and the slides on the other move along separate but parallel guides.

In embodiments, as described below, the arrangement of the manipulator and of the relative slides carrying the rotary tools may be multiplied, so as to have on at least one side of the path of the corrugated board web at least two manipulators, each adapted to position a respective series of rotary tools carried by respective slides. In this way, the positioning is made faster, both in the case in which the manipulator carries a single engaging member, and (even more so) in the case in which the manipulator carries a plurality of engaging elements of the slides carrying the rotary tools.

In the various embodiments, the manipulator may comprise an actuator which controls the movement thereof in a transverse direction with respect to the feed path of the corrugated board web. In the described embodiments, the actuator may be a rotary electric motor, preferably provided with a pinion meshing with a rack parallel to the transverse direction of movement of the manipulator and therefore parallel to the guide along which the manipulator translates.

### BRIEF DESCRIPTION OF THE DRAWINGS

The invention will be better understood by following the description and the accompanying drawings, which illustrate exemplifying and non-limiting embodiments of the invention. More particularly, the drawings show:

FIG. 1 a side view of a cutting-scoring unit for a corrugated board production line;

FIG. 2 an enlargement of a portion of the scoring device of the cutting-scoring unit of FIG. 1 in an embodiment;

FIG. 3 a plan view according to III-III of FIG. 2;

FIG. 3A an enlargement of a detail of FIG. 3;

FIG. 4 a front view according to XIV-XIV of FIG. 3;

FIG. 4A an enlargement of a detail of FIG. 4;

FIGS. 5A-5H a positioning sequence of a series of rotary tools of the scoring device of FIGS. 1 to 4;

FIG. 6 a plan view similar to the view of FIG. 3 in a further embodiment;

FIG. 7 a plan view similar to the view of FIGS. 3 and 6 in still a further embodiment; and

FIGS. 8A to 8H a positioning sequence of a series of rotary tools of the device of FIG. 6.

### DETAILED DESCRIPTION

In the following description of some embodiments, reference will be made to a device for positioning scoring tools. However, it should be understood that the mechanism for positioning the rotary tools, described below, may be used with advantage also to position, for example, rotary cutting tools, typically disc-shaped knives. Therefore, devices for longitudinal processing of a corrugated board web, wherein the rotary tools are cutting tools, rather than scoring tools, also fall within the present disclosure and within the scope of the appended claims. In embodiments, the positioning members of the rotary tools described herein may also be used to position both cutting tools and scoring tools.

In the following description, specific reference is made to an embodiment in which a common slide is used for the movement of one or more manipulators adapted to position tool-holder slides, and for the movement of the tool-holder slides themselves. Some innovative features described herein, however, may be implemented and used with advantage also in a system in which guides are provided which are parallel but separate from each other: one to guide the manipulator, and at least one to guide the tool-holder slides. Specific features claimed in the dependent claims attached here-with can be embodied also in a device including two separate and parallel slides, to guide the manipulator and to guide the tool-holder slides, respectively.

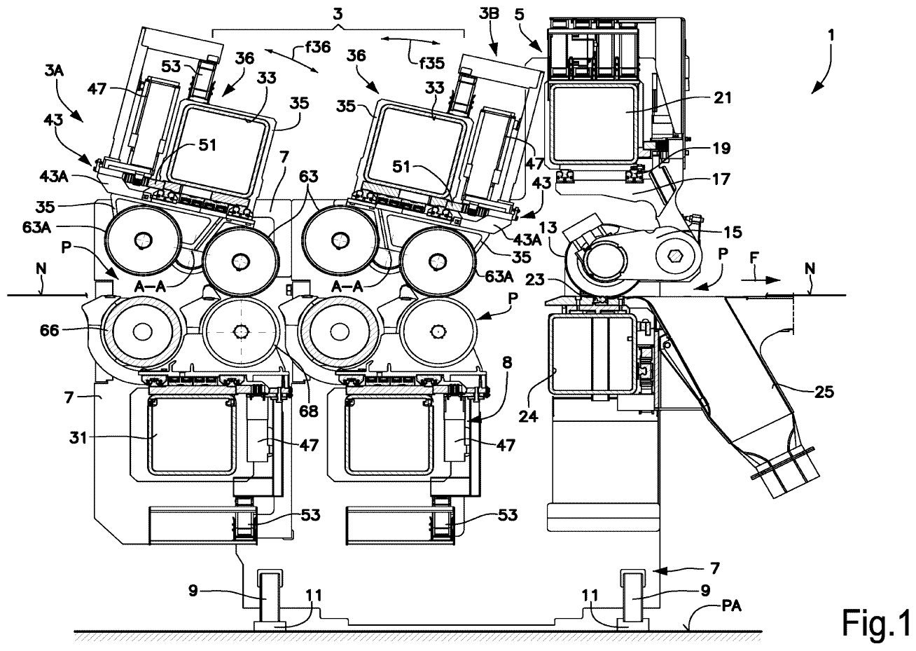

A first embodiment of a device for the continuous processing of a corrugated board web, in particular comprising scoring tools, is described below with reference to FIGS. 1 to 5H.

FIG. 1 illustrates a side view of a cutting-scoring unit for a corrugated board web schematically indicated by N and of which two portions upstream and downstream of the cutting-scoring unit 1 are indicated. The cutting-scoring unit comprises a feed path P of a corrugated board web N. F indicates the feed direction of the corrugated board web N. In FIG. 1, the feed direction of the corrugated board web is horizontal and the feed direction is from left to right. Scoring tools and cutting tools, described in greater detail below, are placed on a first side and on a second side of the feed path P of the corrugated board N. First side and second side of the path mean the area facing one face of the corrugated board and the area facing the other face of the corrugated board advancing along the feed path P, respectively. In the case of a substantially horizontal feed path P, the first side may be the upper side and the second side may be the bottom side, or vice versa, of the feed path P.

The cutting-scoring unit 1 may comprise a scoring station 3 and a cutting device 5. In general terms, the scoring station 3 may comprise one or more groups or series of scoring tools for making scoring lines spaced apart along the width of the corrugated board web N, i.e. spaced in a direction transverse to the machine direction (MD) which is represented by the feed direction (arrow F) of the corrugated board web N along the feed path P.

In the illustrated embodiment, the scoring station 3 comprises two scoring devices 3A, 3B, which are substantially identical to each other. The number of scoring devices may be different from that indicated, for example a single scoring device may be provided, or more than two scoring devices may be provided in sequence. Along the same corrugated board processing line, along which the feed path P develops, other arrangements equal to that illustrated in FIG. 1 may also be provided. In this case, for example, the two arrangements of cutting and scoring members work alternatively, and therefore when one arrangement is in operation the other is prepared for the processing of the next order, after positioning the scoring and/or cutting tools.

The details of one of the scoring devices 3A, 3B will be described in greater detail below. The other scoring device may be substantially the same or different. In the illustrated example, the two scoring devices 3A, 3B are identical to each other.

In the illustrated embodiment, a single cutting device 5 is provided, but this is to be understood as an example and not as limiting.

In some embodiments, the cutting device 5 and the scoring devices 3A, 3B are supported by a common supporting structure 7. The supporting structure 7 may have wheels 9 engaged on guides or tracks 11 integral with a floor PA. The wheels 9 have axes of rotation parallel to the feed direction F of the corrugated board N, so as to allow the entire cutting-scoring unit to move in a transverse direction, for example to follow any small transverse movements of the corrugated board web N which is fed continuously along the feed path P through the cutting-scoring unit 1.

The cutting device 5 may comprise a series of rotary cutting tools 13, for example disc-shaped cutting blades, each of which may be carried by an arm 15 pivoting around a transverse axis with respect to a respective slide 17. In the illustrated example, the slides 17 of the various rotary cutting tools 13 are engaged on guides 19 integral with a cross member 21. In this way, it is possible to adjust the position of each rotary cutting tool 13 in the transverse direction, i.e. in the horizontal direction not parallel to the feed path P. Preferably, the adjustment direction is horizontal and orthogonal to the feed direction of the corrugated board along the feed path P.

In the illustrated embodiment, the individual rotary cutting tools 13 coact with a fixed counter blade 23. The counter blade 23 is carried by a cross member 24. In other embodiments, each rotary cutting tool 13 may coact with a respective rotary cutting counter blade. A pair of suction nozzles 25 is arranged to suck and remove longitudinal trimmings cut along the longitudinal edges of the corrugated board web N.

In the illustrated embodiment, the two scoring devices 3A, 3B are the same and therefore only the scoring device 3A will be described below. If the corrugated board processing line N includes only the scoring devices 3A, 3B, it may be contemplated that one of said scoring devices is in operation and the other awaiting processing of a subsequent order. In this case, the scoring tools of the scoring device standing-by may be positioned as required for the next order.

Alternatively, and especially if more than two scoring devices are provided along the same processing line, it may be provided that two scoring devices are both in operation. This allows a greater number of scoring tools to be brought into operation and/or the minimum distance between two adjacent scoring lines to be reduced. This is because two adjacent scoring lines may be generated by scoring tools belonging to two distinct scoring devices. Therefore, the minimum distance between adjacent scoring lines is not limited by the transverse dimensions of the individual scoring tools placed in the same scoring device.

The scoring device 3A comprises a double scoring system, which allows two different scoring modes to be selected, as will be clarified hereinafter. More particularly, the scoring device 3A comprises two upper scoring units, which work alternately to each other. This configuration is optional and not binding. The innovative aspects of the positioning system of the rotary scoring tools of the present disclosure may also be used in simpler scoring devices where the double scoring mode is not provided.

Hereinafter, the rotary scoring tools of the scoring device 3A will also be referred to simply as “rotary tools”.

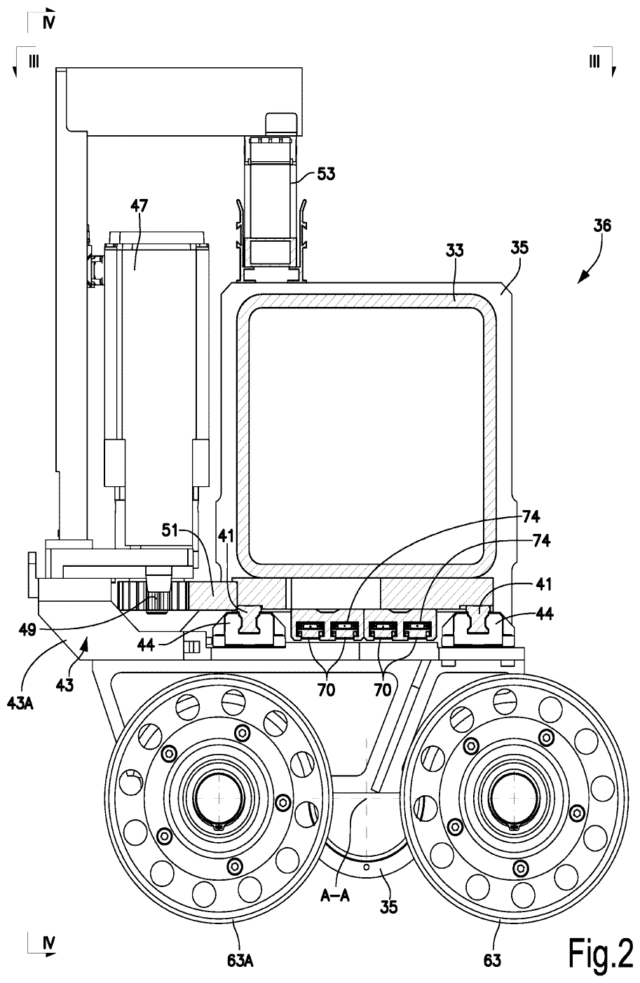

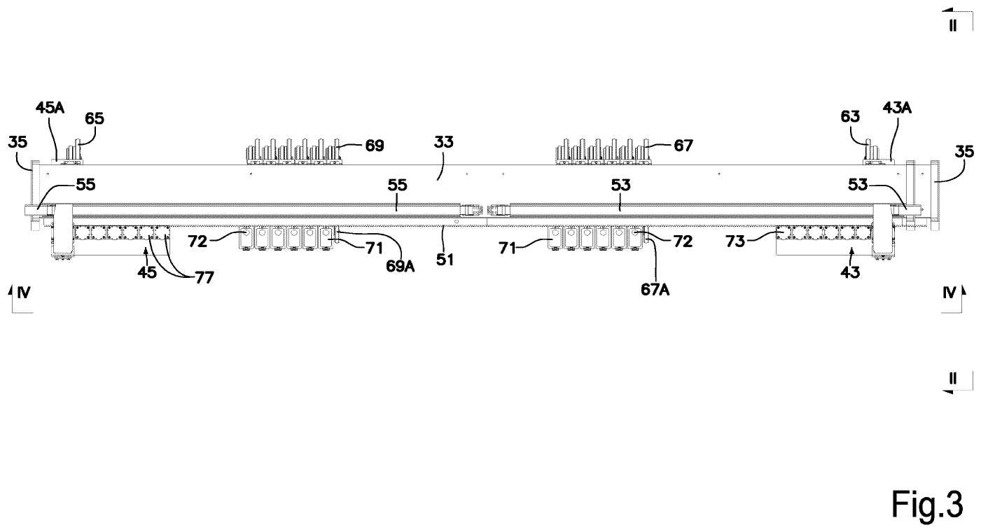

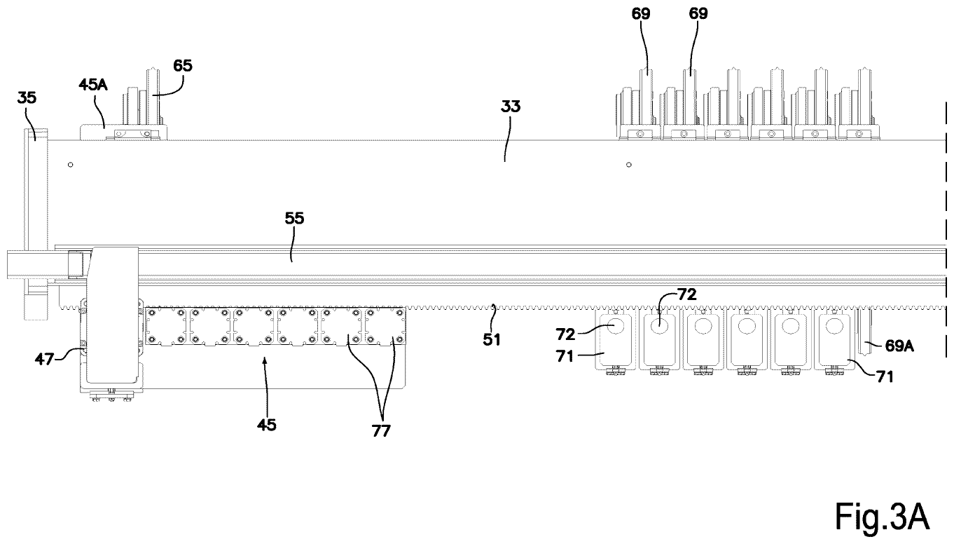

In the illustrated embodiment, the scoring device 3A comprises a lower cross member 31 and an upper cross member 33. In the illustrated example, the lower cross member 31 is rigidly connected to the supporting structure 7, while the upper cross member 33 is carried by a pair of sides 35 hinged around an axis of rotation A-A (see also FIGS. 2 and 3), which allows modifying the angular position of a head 36 formed by the sides 35, the upper cross member 33 and the members carried by the latter. The rotation that can be imposed on the head 36 is indicated with f36. FIGS. 2, 3 and 4 show the head 36 separated from the rest of the scoring device 3A. By rotating the head 36 it is possible to bring into operation one or the other group of scoring tools carried by the head 36 as explained in more detail below. In other embodiments, an upper cross member 33 may be provided rigidly connected to the supporting structure 7, with a single group of scoring tools.

The head 36 and the rotary tools carried by it (described below) are located on one side of the feed path P of the corrugated board web N, i.e. above it, while the cross member 31 and the relative rotary tools are on the other side of the feed path P, i.e. below it.

Mounted on the upper cross member 33 is a guide, hereinafter referred to as adjustment guide 41 (see in particular FIG. 2), on which two manipulators adapted to position the rotary tools, and a plurality of slides, each of them carrying a respective rotary tool, are slidably engaged. The adjustment guide 41 may be a double guide, comprising two parallel sliding tracks. Locking members described below may be placed between the two tracks.

As shown in detail in FIGS. 2, 3, 3A, 4 and 4A, a first manipulator 43 and a second manipulator 45 engage with the adjustment guide 41 by means of shoes 44. The shoes 44 are integral with respective slides 43A and 45A forming part of the two manipulators 43, 45.

In other embodiments, a single manipulator may be provided, for example only the manipulator 43 or only the manipulator 45. The provision of two manipulators allows a faster positioning of the rotary tools, especially when these are provided in a large number, for example more than five or six rotary tools.

Each manipulator 43, 45 is engaged with the adjustment guide 41, for example by means of respective shoes slidably engaged with the tracks forming the adjustment guide 41. The movement of each manipulator 43, 45 along the adjustment guide 41 is controlled by means of a respective actuator 47, for example a hydraulic motor or preferably an electric motor, which rotates a pinion 49 meshing with a rack 51 integral with the cross member 33 and parallel to adjustment guide 41. The movements of the manipulators 43 and 45 along the cross member 33 controlled by the actuators 47 are indicated with f43 and f45.

Numerals 53 and 55 indicate flexible channels for the passage of conduits for supplying control fluid, electric power supply and/or data transmission cables, and the like for the two manipulators 43, 45.

In the embodiment illustrated in the accompanying drawings, each of said first manipulator 43 and second manipulator 45 supports a respective rotary scoring tool, indicated with 63 and 65, respectively. In this embodiment, each rotary tool 63, 65 is double, meaning that it comprises two rotary tools, which work alternatively. The second rotary tool of each manipulator 43, 45 is indicated with 63A and 65A, respectively.

In the angular position of the head 36 shown in FIG. 1, right-hand rotary tools 63, 65 are active (observing the figure), while the left-hand rotary tools (63A, 65A) are inactive. In fact, in the position shown in FIG. 1, the right-hand rotary tools coact with homologous rotary tools 68 which are located on the opposite side, i.e. on the lower side, of the feed path P of the corrugated board web N. Conversely, the rotary tools 63A, 65A on the left are raised with respect to an opposing roller 66 placed under the feed path P of the corrugated board web N. Hereinafter, reference will normally be made to only one of the tools of each pair 63, 63A and 65, 65A.

Further rotary tools 67 are slidably engaged on the adjustment guide 41 which, together with the tool 63 carried by the first manipulator 43, form a first series of rotary tools 63, 67. Also engaged on the adjustment guide 41 are further rotary tools 69 which form, with the tool 65 carried to the second manipulator 45, a second series of rotary tools 65, 69. Each rotary tool 67 and each rotary tool 69 is double, similarly to what is described and illustrated with reference to the rotary tools 63, 63A and 65, 65A carried by the first manipulator 43 and by the second manipulator 45. The second tool of each pair is indicated with 67A and 69A, respectively. Hereinafter, for the sake of brevity, reference will normally be made briefly to only one of the tools of each pair 67, 67A and 69, 69A.

In other embodiments, the tools 63A, 65A, 67A, 69A may be omitted. In still other embodiments, the tools 63A, 65A, 67A, 69A may be present and the tools 63, 65, 67, 69 may be omitted.

Each rotary tool 67, 69 (and more precisely each double tool 67, 67A and 69, 69A) is carried by a respective slide 71, slidably engaged by means of shoes on the tracks forming the adjustment guide 41. The slides 71 may be locked in any transversal position selected along the adjustment guide 41 by means of suitable locking devices positioned between the two tracks forming the adjustment guide 41. These locking devices may be carried by each slide 71, for example, and may comprise brakes coacting with an element integral with the cross member 33. In other more advantageous embodiments, as illustrated in the example shown in the accompanying drawings, the locking devices are fixed to the cross member 33 and may be unique for all the slides 71. In this way, a single command to actuate the locking devices is sufficient to lock all the slides 71. In the illustrated embodiment (see in particular FIG. 2), the locking devices comprise braking members 70 expandable by means of flexible plenums 74, by means of a pressurized fluid, for example. The fluid may be liquid (e.g. water or oil) or gaseous (e.g. air). The braking elements are adapted to block also the manipulators 43, 45.

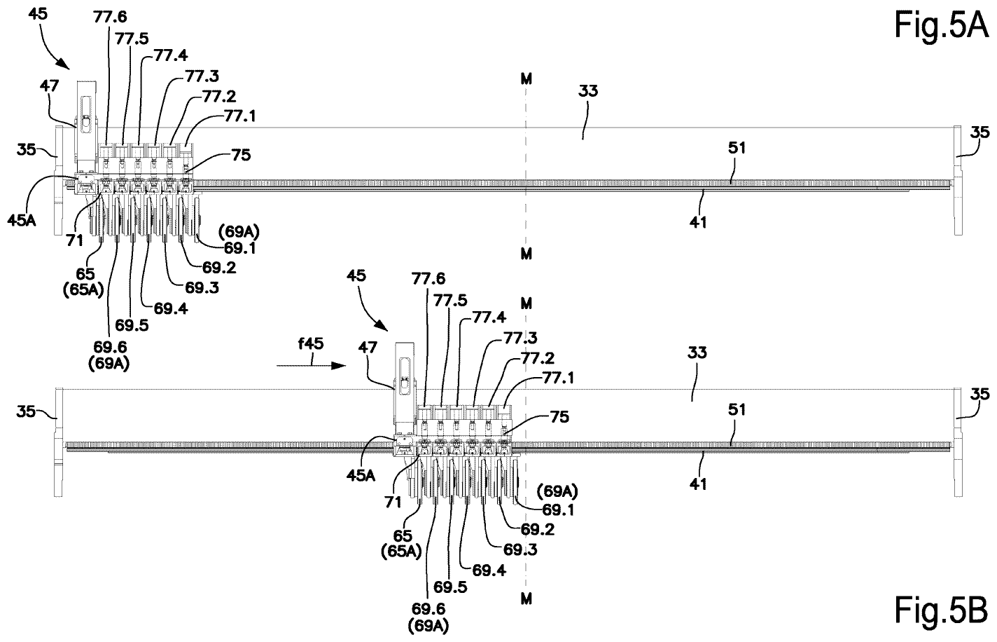

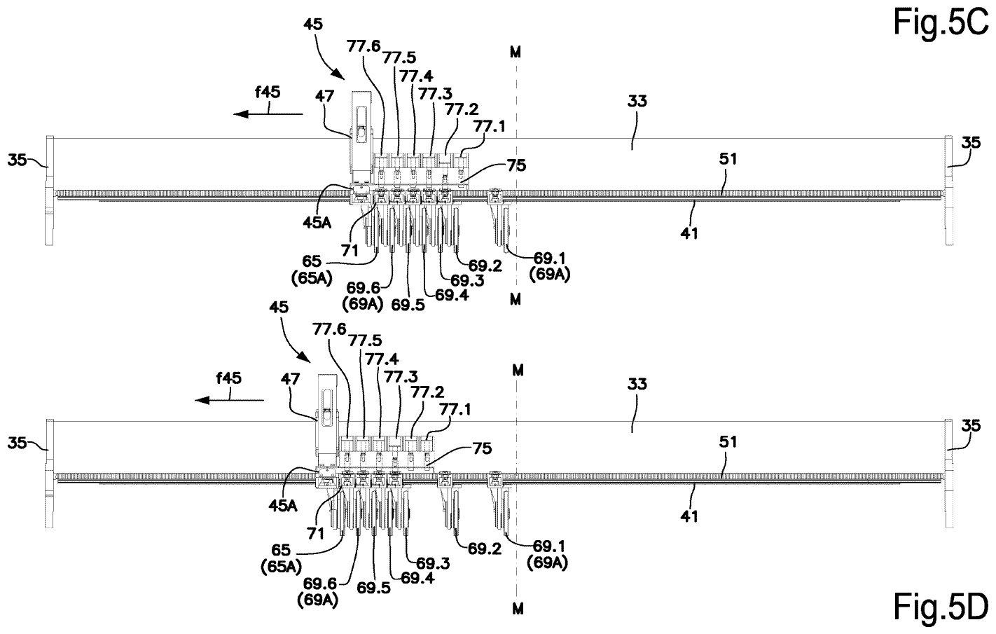

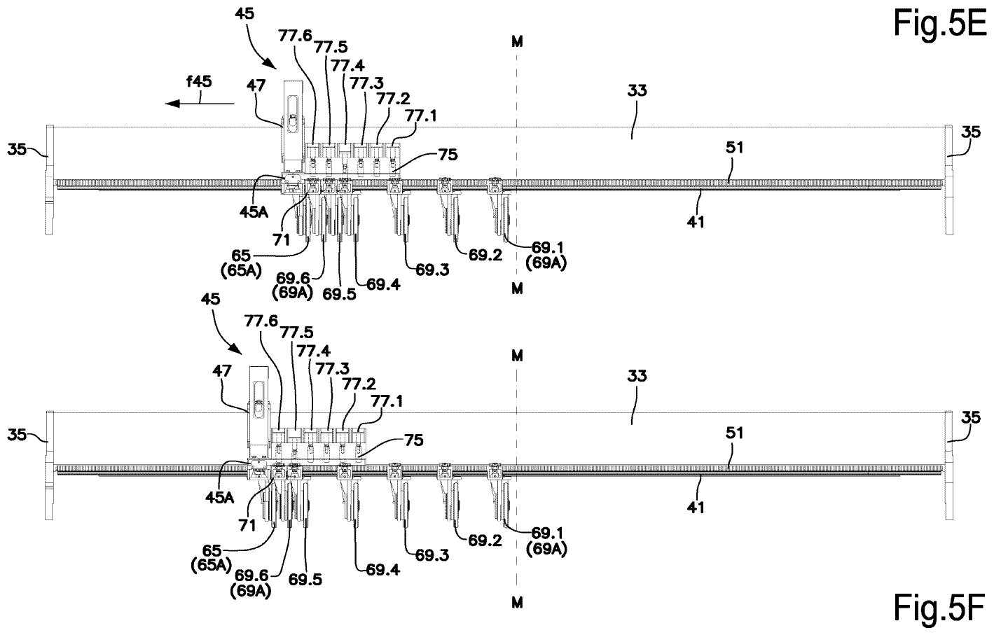

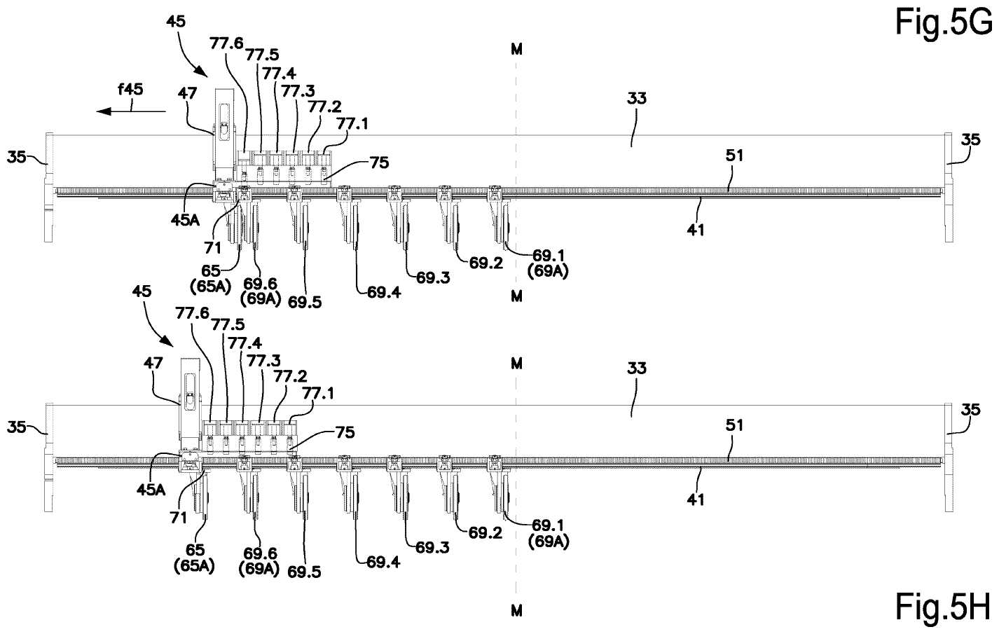

Each slide 71 comprises a coupling seat 72, adapted to coact with a respective engaging element of the corresponding manipulator 43 or 45. In particular, the first manipulator 43 comprises first engaging members consisting of a plurality of engaging elements 73. Each engaging element comprises a pin 75 (see FIGS. 5A-5H) adapted to fit into a corresponding coupling seat 72 of a respective slide 71. Instead of pins 75 and seats 72, other reciprocal coupling members may be provided between the engaging element 73 and the slide 71.

In the illustrated embodiment, each engaging element 73 comprises an actuator, for example a hydraulic (or preferably pneumatic) cylinder-piston actuator, an electric, electromagnetic, mechanical or other actuator, which controls the movement of the pin 75 or other coupling member connecting to the slide 71.

In the embodiment of FIGS. 1 to 5H, the first manipulator 43 comprises a number of engaging elements 73 equal to the number of rotary tools 67. In the illustrated example, the first group of rotary tools comprises six rotary tools 67 and the first manipulator 43 comprises six engaging elements 73, each provided with a pin 75 or other coupling member adapted to be inserted into the coupling seat 72 of a corresponding slide carrying one of the rotary tools 67.

The engaging elements 73 are advantageously aligned with each other in the direction of the adjustment guide 41. The engaging elements 73 may be carried by a bracket integral with the slide 43A by the manipulator 43, so that the whole group of engaging elements 73 moves integrally with the first manipulator 43.

Similarly, the second manipulator 45 comprises a plurality of second engaging members comprising engaging elements 77, equal in number to the number of rotary tools 69 of the second series of rotary tools. Each engaging element 77 may comprise a pin 75 or other coupling element, adapted to be constrained in the corresponding seat 72 of a respective slide 71 of the corresponding rotary tool 69.

The individual engaging elements 73 may be controlled independently from each other, so as to selectively constrain and release each rotary tool 67 of the first series of rotary tools 67 and the respective slide 71 to the first manipulator 43. Similarly, the second engaging elements 77 may be controlled independently from each other and allow each rotary tool 69 of the second series of rotary tools 69 and the respective slide 71 to the second manipulator 45 to be selectively constrained and released. In this way, it is possible to individually position each rotary tool 67, 69 correctly along the adjustment guide 41.

In the embodiment of FIGS. 1 to 5H, rotary tools 68 are arranged on the second side (lower side) of the feed path P of the corrugated board web N, according to a mirror arrangement with respect to the rotary tools 63, 65 and 67, 69. Each rotary tool 68 coacts with one of the tools 63, 65, 67 and 69. In the illustrated embodiment, the rotary tools 68 are divided into a third series of rotary tools coacting with the rotary tools 63, 67 of the first series of rotary tools, and a fourth series of rotary tools, coacting with the rotary tools 65, 69 of the second series of rotary tools. In the illustrated example, the total number of rotary tools of the third series of rotary tools is equal to seven, i.e. equal to the number of rotary tools 63 and 67; and the total number of rotary tools of the fourth series of rotary tools is still equal to seven, i.e. the number of rotary tools 65 and 67.

As mentioned above on the other hand, the rotary tools 63A, 65A, 67A, 69A coact with a single counter-roller 66.

The outermost rotary tools 68, i.e. the ones farthest from the center line of the scoring device 3A, are mounted on a third manipulator 81 and on a fourth manipulator (not visible) in a similar way to that provided for the rotary tools 63, 65. The third manipulator 81 and the fourth manipulator are configured as the first manipulator 43 and the second manipulator 45 and perform the same functions as the latter, described hereinafter. Therefore, each of said third and fourth manipulators has engaging members with the rotary tools 86, which engaging members comprise an engaging element for each of the rotary tools 86, excluding the two outermost ones which are carried directly by the third and fourth manipulator.

In other embodiments, a single manipulator instead of two manipulators may be provided on the lower side of the feed path P.

In some embodiments, the rotary tools placed above the feed path P may be idle, while the rotary tools placed on the lower side of the feed path may be driven. An inverse configuration is not excluded, with the upper tools driven and the lower tools idle, or even a configuration in which all the tools (upper and lower) are driven.

As mentioned, the cutting-scoring units must be configured every time the production order changes, placing an appropriate number of cutting tools and scoring tools in the correct transverse positions with respect to the feed path P of the corrugated board web N.

FIGS. 5A-5H illustrate a positioning cycle of the rotary tools of the second series of rotary tools 65, 69, which are positioned by means of the second manipulator 45. The other rotary tools described above may be positioned in their respective transverse positions by means of the respective first, third and fourth manipulators, with an operating cycle similar to that described below and shown in the sequence of FIGS. 5A-5H for the second manipulator 45. For reasons of simplicity of representation, the sequence of FIGS. 5A-5H only shows the second manipulator 45 and the respective tools 65, 69.

FIG. 5A shows an initial step in which all the rotary tools 69 of the first series are placed in a lateral position, close to each other and approached to the second manipulator 45. The starting position of the rotary tools may be different from the one shown. For example, the rotary tools may be distributed along the development of the adjustment guide 41 in the position in which they were for the processing of the previous order.

The slides 71 are free to slide along the adjustment guide 41, i.e. the braking members 70 of the locking devices are deactivated. In the sequence of FIGS. 5A-5H, for greater clarity, the six rotary tools 69 of the second series of rotary tools are numbered from 69.1 to 69.6, starting from the most central tool, i.e. the one closest to the vertical center plane (trace plane M-M). Similarly, the six engaging elements 77 are here numbered from 77.1 to 77.6 starting from the center line M-M.

Advantageously, in order to initially have all the rotary tools and the respective slides in a well-defined position, without the risk of accidental displacements, for example due to inertia, in one embodiment the positioning may take place by carrying out a preliminary step in which the two manipulators 43, 45 are brought towards the center line M-M (arrow f45 in FIG. 5A) at a mutual distance such that all the slides 71 abut against each other and against the slides 43A, 45A of the manipulators 43, 45. The mutual approach of all the slides with each other and against the slides 43A, 45A of the respective manipulators in a central area ensures the position of the rotary tools with respect to the engaging elements, so that each seat 72 is aligned with the respective pin 75. At this point, all the pins 75 may be inserted into the respective seats 72 of the slides 71 to carry out the positioning according to the sequence described below. In reality, for this purpose it is sufficient to insert the pin 77.1 into the seat 72 of the tool 69.1, and operate in a mirror image with the manipulator 43, not shown in the sequence of FIGS. 5A-5H.

In FIG. 5B, the second manipulator 45 has moved from the position closest to the center line M-M to the left in the figure (arrow f45 in FIG. 5B); with this movement, the manipulator 45 has translated according to the arrow f45 all the slides 71 of the rotary tools 69 and the tool 65 carried by the manipulator r45 itself.

In the position of FIG. 5B, the tool 69.1 has been brought into the position in which it must be for processing the next order.

Once the position of FIG. 5B has been reached, the second rotary tool 69.2, if not already activated previously, is constrained to the second manipulator 45 by means of the respective engaging element 77.2. For this purpose, the pin or other coupling element 75 is inserted into the corresponding seat 72, or other complementary element, of the slide 71 of the second tool 69.2. It is not excluded that all the engaging elements 77, except for the engaging element 77.1, are activated to constrain the respective rotary tools 69.2-69.6 to the second manipulator 45, but this is not necessary.

Having constrained the slide 71 of the second rotary tool 69.2, the movement away from the center line M-M (arrow f45 in FIG. 5C) of the second manipulator 45 causes the dragging of all the rotary tools 69.2, 69.3, 69.4, 69.5, 69.6 as well as of the rotary tool 65, supported directly on the second manipulator 45.

When the second manipulator 45 has reached a position in which the rotary tool 69.2 is in the required final position (FIG. 5C), the engaging element 77.2 releases the slide 71 of the rotary tool 69.2 while the engaging element 77.3 (if not already activated previously) is activated to constrain the slide 71 of the third rotary tool 69.3 to the manipulator 45.

The manipulator 45 then performs a second stroke according to the arrow f45 (FIG. 5D) until the third rotary tool 69.3 is brought into the desired position (FIG. 5E).

The operations described above are repeated to position all the tools 69.1-69.6, as illustrated in detail in the following FIGS. 5F-5G. The manipulator 45 further translates according to f45 to the position in which the rotary tool 65 carried by the manipulator 45 is in the desired final position (FIG. 5H).

At this point, all the slides of the tools 69.1-69-6 and also the manipulator 45 may be locked by activating the braking members 70.

Simultaneously with the operations described above, performed by the second manipulator 45, similar positioning operations may be performed by the first manipulator 43 on the rotary tools 67 of the first series of rotary tools 67, 63, and by the third and fourth manipulators located under the feed path P of the corrugated board web N, to position the rotary tools 68 of the third series of rotary tools and of the fourth series of rotary tools in a corresponding manner.

In some embodiments, it may be provided that the rotary tools 68 underlying the feed path P are constrained to the upper rotary tools 67, 69. In this case, it is sufficient to provide one or two upper manipulators 43, 45 to position all the rotary tools 63, 65, 67, 69, 68.

When the scoring device 3A (or 3B) is set to work with the counter-roller 66 and with the rotary tools 63A, 65A, 67A and 69A, it is sufficient to position, by means of the manipulators 43 and 45, the upper rotary tools 63, 67, 65, 69, i.e. of the rotary tools placed above the feed path P.

At the end of the processing of an order, it is possible to return the rotary tools to the position of FIG. 5A (and similarly for the rotary tools of the other series of rotary tools), simply by translating the manipulator 45 towards the center line M-M until the engaging element 77.1 is brought into alignment with the slide 71 of the rotary tool 69.1. The engaging element 77.1 constrains the slide of the tool 69.1 to the manipulator 45 and the latter translates towards the end of the cross member 33 until it reaches the position of FIG. 5A, dragging all the tools 69.1-69.6 with it, in addition to the tool 65 mounted on the manipulator 45 Alternatively, all the slides 71 may be approached to each other in the central line area M-M by approaching the manipulators 43, 45 to each other in a central position, to carry out a new positioning cycle as described above.

If the corrugated board processing line includes a plurality of scoring devices 3A, 3B, as mentioned above, it is possible to position the rotary tools for the next order while the corrugated board is processed by another scoring device along the processing line.

The positioning cycle described above, performed by the manipulators 43, 45, is extremely rapid even though it is carried out with a very simple manipulator structure and with few low-cost actuators (actuators of the engaging elements 75, 77) and only two actuators of higher cost (motors 47) for each side (upper and lower) of the feed path P of the corrugated board web N. The number of guide channels 53, 55 is reduced to four (one for each manipulator) and no threaded bars and nut screws and relative means for mutual engagement and disengagement between tool slides and nut screws are required, as provided in the devices of the prior art mentioned in the introductory part of the present description.

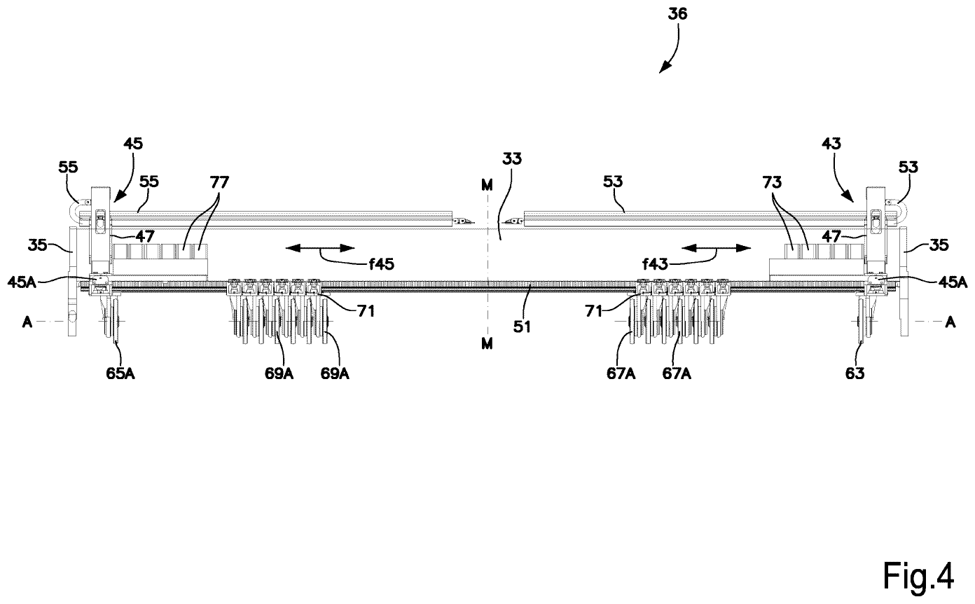

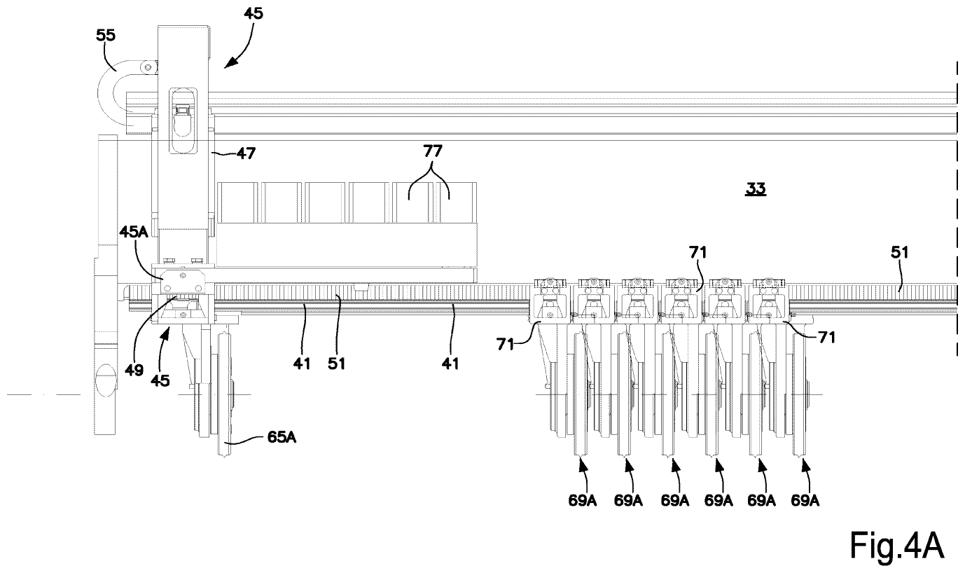

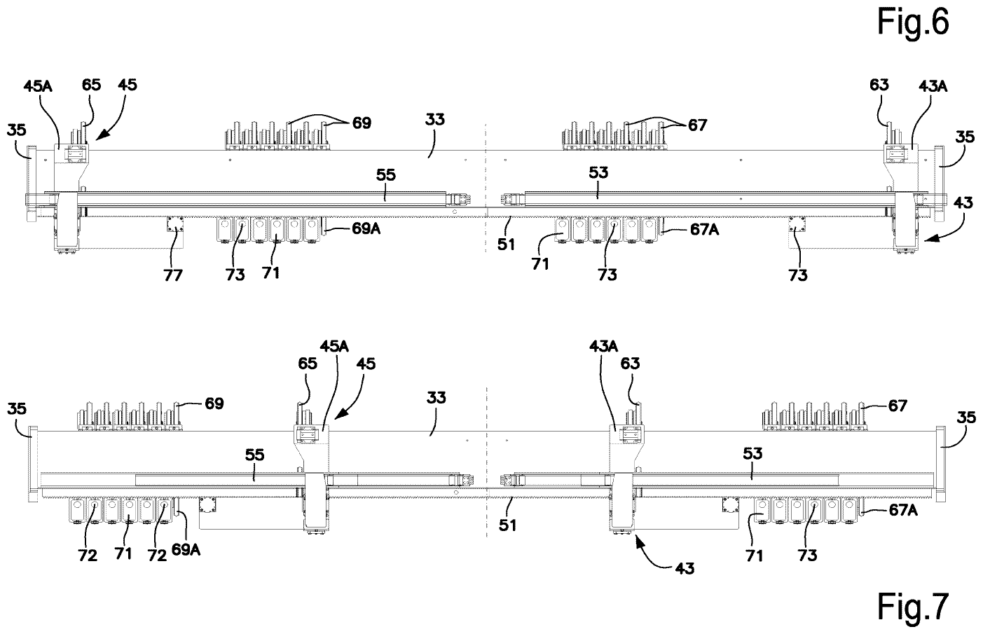

FIG. 6 shows a view similar to the views of FIGS. 3 and 4, in a second embodiment. Same numbers indicate parts that are the same or corresponding to those of the preceding figures, and will not be described again.

The main difference between the embodiment of FIGS. 1 to 4 and the embodiment of FIG. 6 consists in that each manipulator 43, 45 (and possibly the equivalent manipulators placed under the feed path P) comprises a single engaging element 73 and 77, respectively.

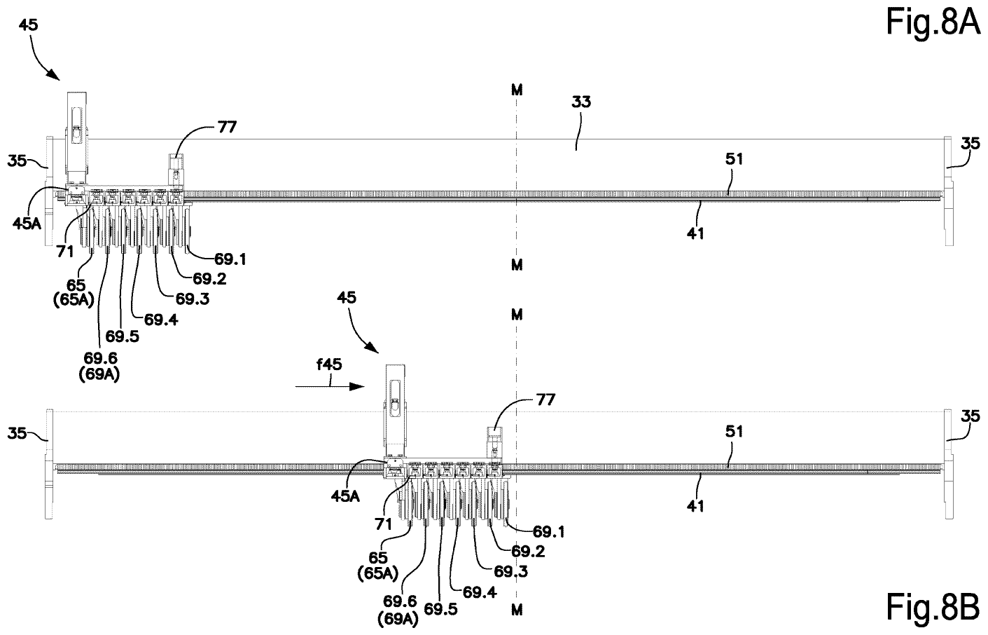

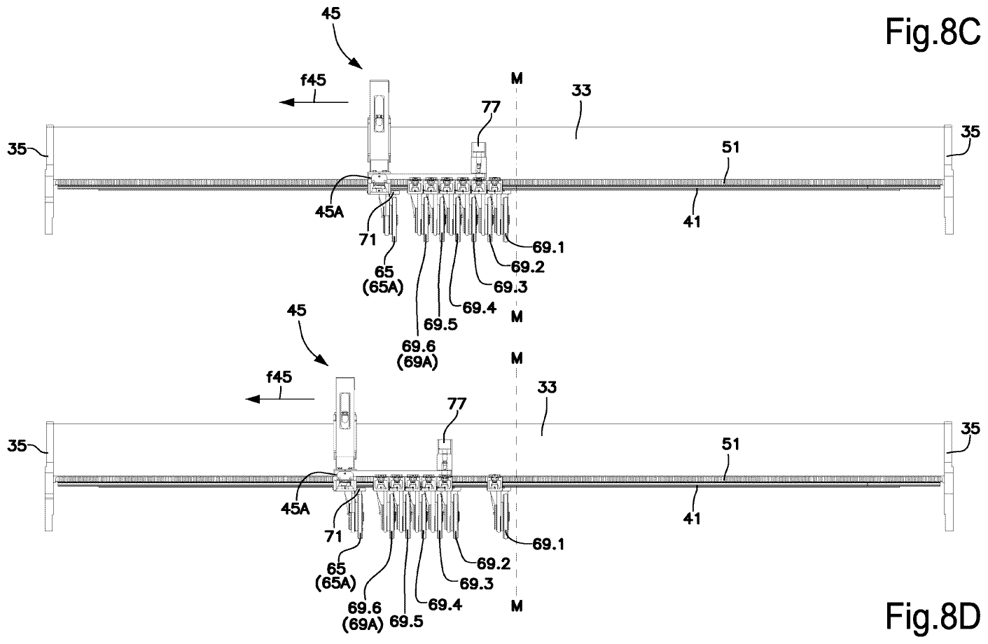

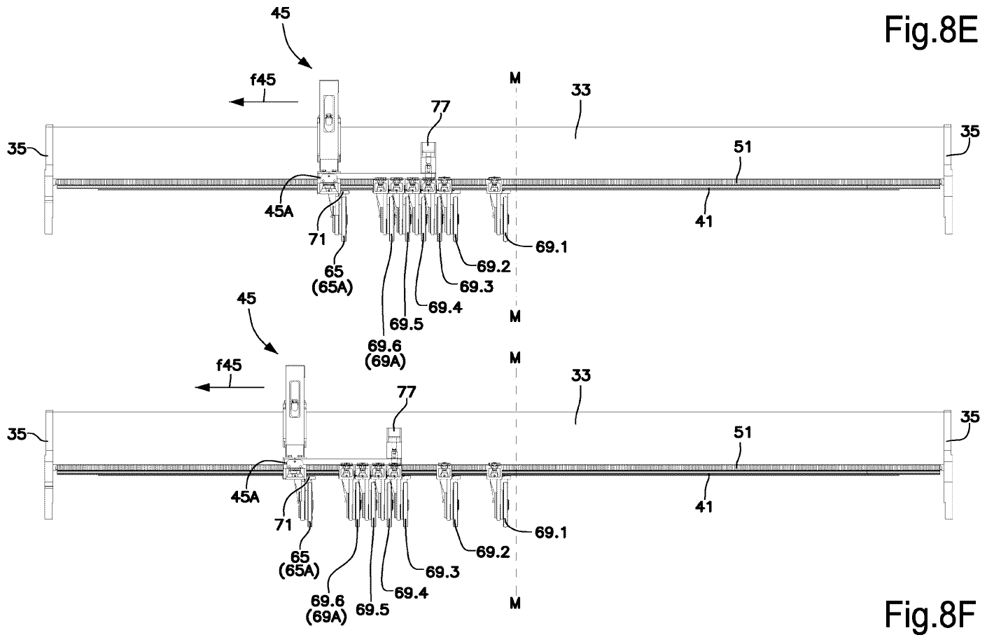

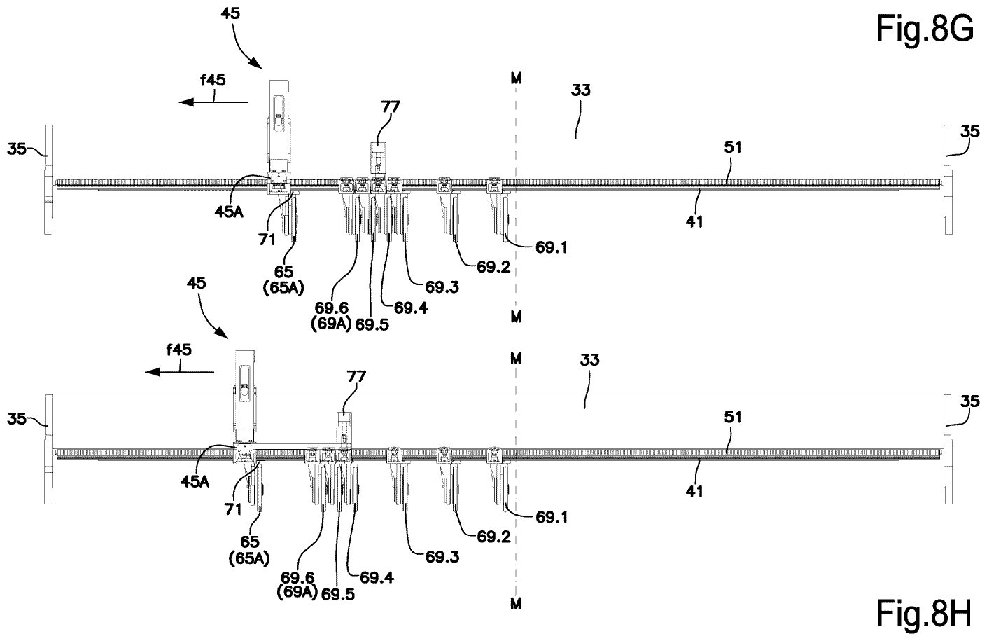

FIGS. 8A-8H illustrate the positioning cycle of the rotary tools 69.1-69.6 and 65 in a similar way to what is illustrated in the sequence of FIGS. 5A-5H for the previously described embodiment. The rotary tools of the other series of rotary tools are positioned in a similar operating sequence.

In FIG. 8A, the rotary tools 65, 69.1-69.6 are all positioned in proximity to the end of the cross member 33. Alternatively, the tools may be distributed along the transversal development of the machine, in the positions required by the previous processing order. In a preliminary step, all the tools may be placed towards the center line M-M, bringing the slides 71 in abutment against each other and against the slides 43A, 45A, as previously described with reference to the sequence of FIGS. 5A. 5H.

In FIG. 8B, the manipulator 45 is moved towards the point where the first tool 69.1 must be positioned. In FIG. 8C, the rotary tool 69.1 has been released in its transverse position along the adjustment guide 41 and, with a movement of one step (corresponding to the distance between two adjacent slides 71) according to the arrow f45, the single engaging element 77 has been brought into alignment with the slide 71 of the rotary tool 69.2 to engage said slide. In FIG. 8D, the manipulator 45 is translated until the tool 69.2 is brought into the final position. The engaging element 77 is released from the slide of the tool 69.2 and, with a movement of one step of the manipulator 45, is brought into alignment with the slide of the rotary tool 69.3 and activated to constrain the rotary tool 69.3 to the manipulator 45. The steps are repeated (FIGS. 8E-8H) until all the rotary tools 69.1-69.6 and 65 are positioned in the desired transverse positions along the adjustment guide 41. After positioning the tools 69.1-69.6 and having brought the manipulator 45 to the position in which the tool 65 is to be placed, the locking devices or the braking members 70 are activated. The same operations are carried out for the other series of rotary tools.

The cycle of FIGS. 8A-8H is slightly slower than the cycle of FIGS. 5A-5H, but requires a smaller number of actuators than required for the embodiment of FIGS. 1 to 5H.

FIG. 7 shows an embodiment modified with respect to FIG. 6, which consists in the different orientation and positioning of the manipulators 43 and 45. In FIG. 7, the manipulators 43, 45 are placed in a central position, while the respective rotary tools 67 and 69 are placed outside the manipulators 43, 45. The tool positioning cycle is substantially the same, except that it starts from the ends of the cross member 33.

In all cases, if the tools to be used for processing the order are less than those available (in the example the total number of upper tools is 14), the excess tools may be parked to the side of the feed path P, i.e., in proximity to one or the other end of the cross member 33.

A transversal positioning system of the type described above may also be provided for positioning the rotary cutting tools 13.

Exemplary embodiments have been described above and illustrated in the accompanying drawings. Those skilled in the art will understand that numerous modifications, omissions and additions may be made with respect to what is specifically described herein, without departing from the scope of the invention as defined in the following claims.

For example, the rotary tools 63 and 65 carried by the manipulators 43, 45 may be omitted and the number of rotary tools 67 and 69 may be increased. This, however, increases the number of system components and therefore may be less beneficial.

Furthermore, the number of scoring units and their configuration may vary with respect to what is illustrated. For example, only one scoring device 3A or 3B may be provided. In still other embodiments, on the other hand, more than two scoring devices and possibly more than one cutting unit or device may be provided. The sequential arrangement of the scoring and cutting devices may be inverted with respect to that illustrated by way of preferred example in FIG. 1.

1-24. (canceled)

25. A device for longitudinal processing of a corrugated board web, comprising:
a feed path for the corrugated board web;
on a first side of the feed path of the corrugated board web, a first series of rotary tools; wherein each rotary tool of the first series of rotary tools is supported on a respective slide, slidably engaged by respective shoes with parallel sliding tracks of a first adjustment guide, said respective slide being adjustable along said first adjustment guide; wherein the first adjustment guide extends in a direction transverse to a direction of feed of the corrugated board web along the feed path; and
a first manipulator adapted to position each said respective slide of the first series of rotary tools along the first adjustment guide; wherein the first manipulator is slidably engaged by said respective shoes with said sliding tracks of the first adjustment guide and is movable therealong.

26. The device of claim 25, wherein the first manipulator comprises first engaging members adapted to temporarily constrain each said respective slide of the first series of rotary tools.

27. The device of claim 26, wherein the first engaging members further comprise at least one first engaging element adapted to engage at least one said respective slide of at least one tool of the first series of rotary tools with the first manipulator.

28. The device of claim 26, wherein the first engaging members further comprise a plurality of said at least one first engaging element, each of said plurality adapted to engage a respective slide of one of the rotary tools of the first series of rotary tools; and wherein each of said plurality of said at least one first engaging element is activatable and deactivatable independently from other of the plurality of said at least one first engaging element.

29. The device of claim 25, further comprising:
on the first side of the path of the corrugated board web, a second series of rotary tools; wherein each tool of the second series of rotary tools is supported on a respective slide, slidably engaged by respective shoes with said tracks of the first adjustment guide and adjustable along said first adjustment guide; and
a second manipulator adapted to position each said respective slide of the second series of rotary tools along the first adjustment guide; wherein the second manipulator is slidably engaged by said respective shoes with said sliding tracks of the first adjustment guide and is movable therealong.

30. The device of claim 29, wherein the second manipulator further comprises engaging members adapted to temporarily constrain each said respective slide of the second series of rotary tools.

31. The device of claim 30, wherein the engaging members of the second manipulator comprise at least one first engaging element to engage the second manipulator and at least one said respective slide of at least one tool of the second series of rotary tools to one another.

32. The device of claim 30, wherein the engaging members of the second manipulator further comprise a plurality of said at least one engaging element, each of said plurality adapted to engage a respective slide of one of the rotary tools of the second series of rotary tools; and wherein each of the engaging elements of the second manipulator is activatable and deactivatable independently from other of the plurality of said at least one engaging element of the second manipulator.

33. The device of claim 29, wherein each of said first manipulator and said second manipulator supports a respective rotary tool.

34. The device of claim 25, wherein an opposing member coacting with each rotating tool arranged on the first side of the feed path of the corrugated board web, is arranged on a second side of the feed path of the corrugated board web.

35. The device of claim 25, further comprising:
on a second side of the feed path of the corrugated board web, a third series of rotary tools; wherein each tool of the third series of rotary tools is supported on a respective slide, slidably engaged by respective shoes with tracks of a second adjustment guide and adjustable along said second adjustment guide; wherein the second adjustment guide extends in a direction orthogonal to the direction of feed of the corrugated board web along the feed path; and
a third manipulator adapted to position slides of the third series of rotary tools along the second adjustment guide; wherein the third manipulator is slidably engaged by respective shoes with said tracks of the second adjustment guide and is movable therealong.

36. The device of claim 35, wherein the third manipulator further comprises third engaging members adapted to temporarily constrain each of the slides of the third series of rotary tools.

37. The device of claim 36, wherein the third engaging members further comprise at least one third engaging element adapted to engage at least one slide of at least one tool of the third series of rotary tools with the third manipulator.

38. The device of claim 37, wherein the third engaging members further comprise a plurality of third engaging elements, each adapted to engage a respective slide of one of the rotary tools of the third series of rotary tools; and wherein each of said third engaging elements is activatable and deactivatable independently from other of the plurality of said at least one third engaging element.

39. The device of claim 35, further comprising:
on the second side of the feed path, a fourth series of rotary tools; wherein each tool of the fourth series of rotary tools is supported on a respective slide, slidably engaged by respective shoes with the tracks of the second adjustment guide and adjustable along said second adjustment guide; and
a fourth manipulator adapted to position slides of a fourth series of rotary tools along the second adjustment guide; wherein the fourth manipulator is slidably engaged by respective shoes with said tracks of the second adjustment guide and is movable therealong.

40. The device of claim 39, wherein the fourth manipulator further comprises engaging members adapted to temporarily constrain each slide of the slides of the fourth series of rotary tools.

41. The device of claim 40, wherein the engaging members of the fourth manipulator comprise at least one first engaging element between the fourth manipulator and at least one slide of at least one tool of the fourth series of rotary tools.

42. The device of claim 40, wherein the engaging members of the fourth manipulator comprise a plurality of engaging elements, each adapted to engage a respective slide of one of the rotary tools of the fourth series of rotary tools; and wherein each engaging element of the fourth manipulator is activatable and deactivatable independently from other of the plurality of engaging elements of the fourth manipulator.

43. The device of claim 25, wherein the rotary tools are scoring tools.

44. The device of claim 25, wherein the rotary tools are cutting tools.

45. The device of claim 35, wherein the first adjustment guide, or the second adjustment guide, or both the first adjustment guide and the second adjustment guide comprise two parallel tracks, integral with a respective cross member and wherein blocking devices, adapted to block the slides of the rotary tools with respect to a respective adjustment guide of said first adjustment guide and said second adjustment guide are positioned between the two parallel tracks of the respective adjustment guide.

46. A device for longitudinal processing of a corrugated board web, comprising:
a feed path for the corrugated board web;
on a first side of the feed path of the corrugated board web, a first series of rotary tools; wherein each rotary tool of the first series of rotary tools is supported on a respective slide, slidably engaged with a first adjustment guide and adjustable along said first adjustment guide; wherein the first adjustment guide extends in a direction transverse to a direction of feed of the corrugated board web along the feed path;
a first manipulator adapted to position each said respective slide of the first series of rotary tools along the first adjustment guide;
respective engaging members supported on the first manipulator and adapted to temporarily constrain said each respective slide to transfer said respective slide in a correct position; and
at least one additional rotary tool supported on the first manipulator.

47. A device for longitudinal processing of a corrugated board web, comprising:
a feed path for the corrugated board web;
on at least a first side of the feed path of the corrugated board web, a first series of rotary tools; wherein each rotary tool of the first series of rotary tools is supported on a respective slide, slidably engaged with a first adjustment guide and adjustable along said first adjustment guide; wherein the first adjustment guide extends in a direction transverse to a direction of feed of the corrugated board web along the feed path;
a first manipulator adapted to position each said respective slide of the first series of rotary tools along the first adjustment guide;
on the first manipulator, engaging members adapted to temporarily constrain each said respective slide of the first series of rotary tools; wherein the first engaging members comprise a plurality of first engaging elements, each of said plurality of first engaging members adapted to engage a respective slide of one of the rotary tools of the first series of rotary tools; and wherein each of said first engaging elements is activatable and deactivatable independently from other of the plurality of the first engaging elements.
